(19) United States
(12) Patent Application Publication
(10) Pub. No.: US 2024/0084949 A1
(43) Pub. Date: Mar. 14, 2024

(54) PLUMBING COMPONENT WITH A COATING AND METHOD FOR COATING A PLUMBING COMPONENT

(71) Applicant: Grohe AG, Hemer (DE)

(72) Inventors: Christian ZIMMERMANN, Hemer (DE); Andreas BLUMENBERG, Ense (DE)

(73) Assignee: Grohe AG, Hemer (DE)

(21) Appl. No.: 18/270,299

(22) PCT Filed: Mar. 8, 2022
(86) PCT No.: PCT/EP2022/055926

§ 371 Date: Jun. 29, 2023

(30) Foreign Application Priority Data
Mar. 12, 2021 (DE) 10 2021 106 078.8

(51) Int. Cl. F16L 58/08; C22C 9/02; C25D 3/38; C25D 3/56; C25D 3/58; C25D 5/12; C25D 7/04

(52) U.S. Cl. CPC F16L 58/08; C22C 9/02; C25D 3/38; C25D 3/562; C25D 3/58; C25D 5/12; C25D 7/04

(57) ABSTRACT

A plumbing component (1) having a coating (2) with an outer layer (3), wherein the outer layer (3) is at least partially made of copper or a copper alloy. In addition, a method for coating the plumbing component (1).

The present invention relates to a plumbing component with a coating and a method for coating a plumbing component. The plumbing component may be a component for a sanitary faucet, by means of which a liquid may be dispensed at a wash basin, a shower, bathtub and/or a WC.

Sanitary faucets generally have plumbing components in the form of control elements, such as actuating levers, activation buttons and/or actuating pushbuttons, which are touched by users during use. Bacteria and/or viruses can accumulate on the control elements, which can cause diseases. To prevent a transmission of the bacteria and/or viruses to different users, the control elements must frequently be disinfected. This is the case when the sanitary faucets are installed in hospitals or residential facilities for senior citizens.

Based thereon, this invention addresses the problem of at least partially solving the problems indicated with reference to the prior art and specifying a plumbing component, by means of which the cost for a disinfection may be at least partially reduced. In addition, a method for coating a plumbing component will also be specified, by means of which the cost for disinfecting the plumbing component may be at least reduced.

These problems are solved using a plumbing component and a method according to the features of the independent claims. Further advantageous embodiments of the invention are specified in the dependent claims; however, the invention is not limited to these. The invention will be explained in greater detail based on the relevant description. It will be appreciated that the features listed individually in the dependent claims may be combined in any technologically useful manner and define further embodiments of the invention. In addition, the features indicated in the claims are further specified and explained in the description, wherein further preferred embodiments of the invention are illustrated.

A plumbing component which has a coating with an outer layer contributes to solving the problem, wherein the outer layer is made at least in part of copper or a copper alloy.

In particular, the plumbing component is a plumbing component for a sanitary faucet. A sanitary faucet is used to provide a liquid on demand, in particular water, at a wash basin, sink, shower, bathtub and/or toilet. Furthermore, such sanitary faucets may be used to mix cold water and warm water to mixed water at a desired mixed-water temperature and/or to dispense the mixed water. In the case of known sanitary faucets, the mixed water may be conducted from a mixing valve, for instance via at least one liquid channel in a housing of the sanitary faucet to an outlet opening of the housing. The plumbing component may be used for instance to set the mixed water temperature and/or to set a dispensed quantity of the water or mixed water. When using the plumbing component for the toilet, the plumbing component may be used for instance to actuate a flushing of the toilet. In addition, the plumbing component may be a technical component, which is used for water supply and/or wastewater disposal. In particular, the plumbing component may be used to provide water on demand at a wash basin, sink, shower, bathtub and/or toilet. Furthermore, the plumbing component may be a housing or an actuating element, such as an actuating lever, an actuation button, an actuating plate and/or rotating element, for such a technical component and/or sanitary faucet.

The plumbing component has a surface, which is at least partially coated with a coating. The coating may be formed from a plurality of (completely or partially) overlapping individual layers and/or have a layer thickness of approx. 1 nm (nanometers) to approx. 20 μm (micrometers). An outer layer of the coating (e.g., comprising a surface toward or in contact with the environment) is made at least partially of copper or a copper alloy. If the coating has a plurality of layers, the outer layer is an upper layer or the layer furthest from the base material. This can mean that no further layer of the coating is formed on the outer layer. In addition, this can mean that the outer layer (immediately or directly) adjoins an outer environment of the plumbing component and/or the outer layer may be touched by a user of the plumbing component. The coating, the individual layers of the coating and/or the outer layer are galvanically deposited on the surface of the plumbing component. The coating, the individual layers of the coating and/or the outer layer are not formed or produced by physical vapor deposition. The copper alloy may be for instance bronze or white bronze. The copper or the copper alloy has antibacterial, antiviral and/or virustatic properties, so that a disinfection of the coated surface of the plumbing component is not necessary or the cost for disinfection of the plumbing component may be at least reduced.

The plumbing component may be made at least partially or (substantially) completely of copper, zinc, aluminum, plastic and/or iron (base material). The plumbing component may be made at least partially or (substantially) completely of an alloy, which comprises copper, zinc, aluminum and/or iron (base material). For instance, the plumbing component may be made at least partially of zinc die cast. Furthermore, the plumbing component may be made at least partially of plastic.

The coating can comprise a first intermediate layer, which is at least partially made of copper. The first intermediate layer is optional. The first intermediate layer is a layer, which is formed between a surface (of the base material) of the plumbing component and the outer layer. Furthermore, the first intermediate layer may be formed (immediately or directly) on the surface of the plumbing component. The first intermediate layer may for instance be deposited from an alkaline, acid and/or neutral electrolyte.

The coating may comprise a second intermediate layer, which is at least partially made of bright nickel, semi-bright nickel or matte nickel. The second intermediate layer is optional. In particular, the second intermediate layer may be at least partially made of bright nickel, semi-bright nickel and/or matte nickel. The second intermediate layer is in particular a layer, which is formed between the surface of the plumbing component and the outer layer. Furthermore, the second intermediate layer may be formed (immediately or directly) on the first intermediate layer of the coating.

The coating may comprise a third intermediate layer, which is at least partially made of a nickel phosphorus alloy. The third intermediate layer is optional. Furthermore, the third intermediate layer may be made at least partially of an electrolytically deposited and/or continuous or continuously formed nickel phosphorus alloy. The third intermediate layer is a layer, which is formed between the surface of the plumbing component and the outer layer. Furthermore, the third intermediate layer may be formed (immediately or directly) on the second intermediate layer of the coating. A mass fraction of the phosphorus in the nickel phosphorus alloy may be at least 8%. The mass fraction of the phosphorus in the nickel phosphorus alloy is preferably 8% to 14%, especially preferably 10% to 12%. The third intermediate layer of the nickel phosphorus alloy is electrolytically deposited on the plumbing component. The nickel phosphorus alloy assumes the function of corrosion protection. Hence, the nickel phosphorus alloy prevents to a great extent corrosion on the plumbing component and hence improves the corrosion properties of decorative coatings with functional character. Therefore, damages, incompletely sealed or porous coatings lead to a considerably reduced corrosion trend of the plumbing component, so that a component failure and/or optical defects are avoided.

The copper alloy can comprise tin. In addition, the copper alloy can comprise zinc.

The copper alloy can have at least the following mass fractions:
45% to 90% copper;
10% to 55% tin; and
0% to 15% zinc.

According to a further aspect, a method for coating a plumbing component is also specified, comprising at least the following steps:
a) provision of the plumbing component; and
b) coating the plumbing component with a coating, wherein an outer layer is formed by galvanic deposition, which consists at least partially of copper or a copper alloy.

The provision of the plumbing component in step a) and/or the coating of the plumbing component in step b) occurs in particular at least partially in an electrolytic bath. In step b) an electric current, in particular direct current, is conducted through the electrolytic bath, so that copper or the copper alloy is deposited on the surface of the plumbing component. The plumbing component may be electrically connected to a negative pole, and thus serve as a cathode. In addition, prior to step b), during step b) and/or after step b) the first intermediate layer, second intermediate layer and/or third intermediate layer may be formed.

For further details about the method, reference is made in full to the description of the plumbing component.

According to a further aspect, the use of a coating with an outer layer at least partially consisting of copper or a copper alloy in a plumbing component for setting an antibacterial, antiviral and/or virustatic property is proposed, to reduce or prevent disinfection processes in the plumbing component.

For further details about the use, reference in full is made to the description of the plumbing component.

The invention and the technical environment are explained in more detail below with reference to the figures. It should be noted that the FIGURE shows a particularly preferred embodiment variant of the invention, but the invention is not limited thereto. In schematic manner:

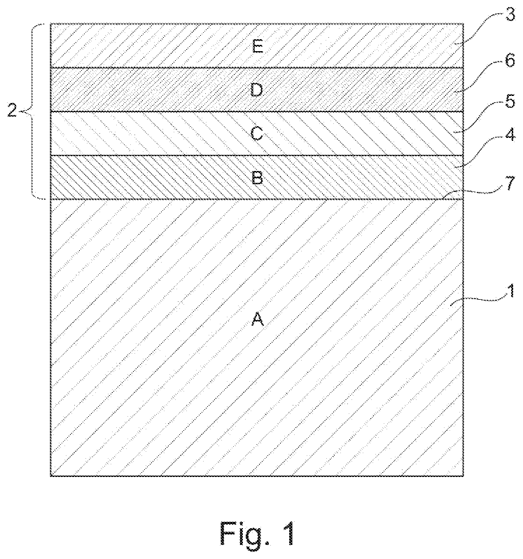

FIG. 1: shows a plumbing component in a sectional representation.

FIG. 1 shows a plumbing component 1 in a sectional representation. The plumbing component 1 has a coating 2 on a surface 7. The coating 2 comprises a first intermediate layer 4 made of copper, a second intermediate layer 5 of bright nickel, semi-bright nickel or matte nickel, a third intermediate layer 6 made of a nickel phosphorus alloy and an outer layer 3 made of a copper alloy.

By means of the present invention, the cost for disinfecting the plumbing component 1 may be reduced.

### LIST OF REFERENCES

1 plumbing component
2 coating
3 outer layer
4 first intermediate layer
5 second intermediate layer
6 third intermediate layer
7 surface

1. A plumbing component (1) having a coating (2) with an outer layer (3), wherein the outer layer (3) is at least partially made of copper or a copper alloy.

2. The plumbing component (1) according to claim 1, wherein the plumbing component (1) is at least partially made of copper, zinc, aluminum, plastic or iron or at least partially made of an alloy, comprising copper, zinc, aluminum or iron.

3. The plumbing component (1) according to claim 1, wherein the coating (2) comprises a first intermediate layer (4), which is at least partially made of copper.

4. The plumbing component (1) according to claim 1, wherein the coating (2) comprises a second intermediate layer (5), which is at least partially made of bright nickel, semi-bright nickel or matte nickel.

5. The plumbing component (1) according to claim 1, wherein the coating (2) comprises a third intermediate layer (6), which is at least partially made of a nickel phosphorus alloy.

6. The plumbing component (1) according to claim 1, wherein the copper alloy comprises tin.

7. The plumbing component (1) according to claim 1, wherein the copper alloy has at least the following mass fractions:
45% to 90% copper;
10% to 55% tin; and
0% to 15% zinc.

8. A method for coating a plumbing component (1), having at least the following steps:
a) provision of the plumbing component (1); and
b) coating the plumbing component (1) with a coating (2), wherein an outer layer (3) is formed by galvanic deposition, which consists at least partially of copper or a copper alloy.
